(19) United States
(12) Patent Application Publication
(10) Pub. No.: US 2012/0251676 A1
(43) Pub. Date: Oct. 4, 2012

(54) REDUCED FAT, HIGH MOISTURE READY TO EAT DESSERT

(75) Inventors: Zachary Caplan, Bronx, NY (US); Richard Leshik, Brookfield, CT (US); Yeong-Ching Albert Hong, Kildeer, IL (US)

(73) Assignee: KRAFT FOODS GLOBAL BRANDS LLC, Northfield, IL (US)

(21) Appl. No.: 13/416,606

(22) Filed: Mar. 9, 2012

Related U.S. Application Data
(60) Provisional application No. 61/451,923, filed on Mar. 11, 2011.

(51) Int. Cl. A23L 1/0522; A23P 1/08

(52) U.S. Cl. 426/103; 426/506; 426/508; 426/474; 426/576; 426/578

(57) ABSTRACT

Methods and compositions relating to a foodstuff having a first component with a first soluble solids ratio; and a second component with a second soluble solids ratio, wherein the second component is a foodstuff comprising (i) about 50% to about 70% water; (ii) about 7% to about 17% hard fat; (iii) about 0.1% to about 5% protein source; and (iv) about 0.1% to about 20% water binder, the foodstuff having a gel strength of about at least 100, further wherein the foodstuff does not comprise lecithin; wherein the first and second components are arranged in discrete layers to form the multi-texture, ready-to-eat foodstuff and wherein the first and second soluble solid ratios have a relative difference of less than about 12 percent.

### CROSS-REFERENCE TO RELATED APPLICATIONS

This application claims priority of U.S. Provisional Patent Application No. 61/451,923, filed Mar. 11, 2011, the entire content of which is expressly incorporated herein by reference thereto.

### BACKGROUND OF THE INVENTION

The present invention generally relates to food technology, and more particularly, to ready-to-eat foodstuffs having a desirable texture, and methods of manufacturing the same.

### BRIEF SUMMARY OF THE INVENTION

Disclosed herein is a method for preparing a foodstuff, comprising preparing a fluid composition comprising about 50% to about 70% water, about 7% to about 17% hard fat, about 0.1% to about 5% protein source, and about 0.1% to about 20% water binder; heating the fluid composition to a temperature above the melting point of the hard fat, and allowing the fluid composition to cool to form a foodstuff having a gel strength of about at least 100, wherein the fluid composition is fluid above a temperature of about 80° F. In an aspect of one embodiment, the foodstuff does not comprise lecithin. Also disclosed herein is a foodstuff comprising about 50% to about 70% water; about 7% to about 17% hard fat; about 0.1% to about 5% protein source; and about 0.1% to about 20% water binder. The foodstuff has a gel strength of about at least 100 and does not comprise lecithin. In an embodiment, the foodstuff comprises lecithin. In an embodiment, the composition further comprises a fat crystallization promoter.

In an embodiment, the fluid composition is heated at a temperature and time sufficient for pasteurization. In an aspect of an embodiment, the method includes an ultra high temperature (UHT) step.

In an embodiment, the foodstuff has a water activity about at least 0.85 and has about less than 5% evaporation during and/or after processing.

In an embodiment, the hard fat has a melting point above 90 degrees Fahrenheit. In an embodiment, the melting point is about 98 degrees Fahrenheit to about 105 degrees Fahrenheit.

In an embodiment, the protein source is nonfat dry milk or a protein-based emulsifier.

In an embodiment, the fluid composition further comprises an ingredient selected from the group consisting of a monoglyceride, a diglyceride, or a combination thereof.

In an embodiment, the water binder comprises compositions selected from the group consisting of a cocoa, starch, gelatin, gums, grains, gelling agents, fiber, dextrins or combinations thereof.

In an embodiment, the fluid composition further comprises at least one texture-modifying particulate ingredient.

In an embodiment, the method includes an aeration step. In an embodiment, the method includes a homogenization step. In an embodiment, the foodstuff is homogenized prior to cooling.

Also disclosed herein is a method for preparing a multi-texture, ready-to-eat foodstuff comprising preparing a first component with a first soluble solids ratio; preparing a second component with a second soluble solids ratio, wherein the second component is a foodstuff comprising about 50% to about 70% water; about 7% to about 17% hard fat; about 0.1% to about 5% protein source; and about 0.1% to about 20% water binder, the foodstuff having a gel strength of about at least 100, and combining the first and second components to form the multi-texture, ready-to-eat foodstuff; wherein the first and second soluble solid ratios have a relative difference of less than about 12 percent. In an aspect[[TS throughout refer to an aspect of something]], the foodstuff does not comprise lecithin.

Also disclosed herein is a multi-texture, ready-to-eat foodstuff comprising a first component with a first soluble solids ratio; and a second component with a second soluble solids ratio, wherein the second component is a foodstuff comprising about 50% to about 70% water; about 7% to about 17% hard fat; about 0.1% to about 5% protein source; and about 0.1% to about 20% water binder. The first and second components are arranged in discrete layers to form the multi-texture, ready-to-eat foodstuff and wherein the first and second soluble solid ratios have a relative difference of less than about 12 percent. The foodstuff has a gel strength of about at least 100. In an embodiment, the foodstuff does not comprise lecithin.

In an embodiment, the composition further comprises a fat crystallization promoter.

### DETAILED DESCRIPTION OF THE INVENTION

Embodiments of the invention provide, in part, non-baked, ready-to-eat (RTE) foodstuffs having a desirable texture, as well as methods of making such foodstuffs. By way of example, such foodstuffs may have a candy bar-like or a fudge-like texture.

In an embodiment, an RTE foodstuff may be prepared from a blend of water, fat, protein, and water binder. In an embodiment, the protein is a milk protein. In an embodiment, an RTE foodstuff may be a water-containing, heat processable, fluid composition including hard fat, a protein source, and a water binder. In one embodiment, an RTE foodstuff further comprises a fat crystallization promoting agent, as described in detail herein. Sweeteners and/or flavorings may be added to provide the desired level of sweetness or desired flavor profile. In an embodiment, additional functional ingredients may be added as desired, including emulsifiers (including protein-based emulsifiers and/or non-protein based emulsifiers, or combinations thereof), stabilizers, thickeners, foaming agents, nutrients, colors, and the like. In another embodiment, processing steps may include one or more of mixing, homogenization, heating, filling, layering and cooling of the RTE foodstuff ingredients. It will be understood that the order of such steps may be modified as necessary to prepare a desired product. In one embodiment, the fluid composition is placed into a suitable container for the cooling and/or setting steps.

In another embodiment, a method of preparing a ready-to-eat (RTE) foodstuff is provided, wherein a water-containing, heat processable, fluid composition, including a blend of water, fat, protein, and water binder, is prepared, processed, and subsequently allowed to cool and set to prepare the final RTE foodstuff product. In an embodiment, the protein is a milk protein.

An exemplary RTE foodstuff may be prepared as a fluid composition. In one embodiment, the fluid composition may be prepared containing about at least 50% water. In one embodiment, the fluid composition may be prepared containing from about 50% to about 70% water. In another embodiment an RTE foodstuff may contain about at least 50% water, about at least 55% water, about at least 60% water, about at least 65% water, about at least 70% water, about at least 75% water, about at least 80% water, or about at least 85% water. In another embodiment an RTE foodstuff may contain at least 50% water, at least 55% water, at least 60% water, at least 65% water, at least 70% water, at least 75% water, at least 80% water, or at least 85% water. In another embodiment an RTE foodstuff may contain about 50% water, about 55% water, about 60% water, about 65% water, about 70% water, about 75% water, about 80% water, or about 85% water.

In one embodiment, there is about 5% or less evaporation of water from an exemplary RTE foodstuff during and/or after processing. Preferably, an RTE foodstuff has substantially no evaporation during and/or after processing. In an embodiment, the final moisture content of an RTE foodstuff is about the same as the total amount of water added during processing. In another embodiment, an RTE foodstuff has about 0.5% evaporation or less, about 1% evaporation or less, about 2% evaporation or less, about 3% evaporation or less, about 4% evaporation or less, about 5% evaporation or less, about 6% evaporation or less, about 7% evaporation or less, about 8% evaporation or less, about 9% evaporation or less, or about 10% evaporation or less after processing. In another embodiment, an RTE foodstuff has 0.5% evaporation or less, 1% evaporation or less, 2% evaporation or less, 3% evaporation or less, 4% evaporation or less, 5% evaporation or less, 6% evaporation or less, 7% evaporation or less, 8% evaporation or less, 9% evaporation or less, or 10% evaporation or less after processing.

In another embodiment, an exemplary RTE foodstuff also has a water activity of greater than about 0.85. The water activity (Aw) is defined as follows: Aw=P/Po, wherein P is the partial pressure of water in the food product at temperature T, and Po is the saturated water pressure of pure water at the given temperature T. In an embodiment, an RTE foodstuff has a water activity of greater than about 0.8, greater than about 0.85, greater than about 0.9, greater than about 0.95, or about 1.0. In an embodiment, an RTE foodstuff has a water activity of greater than 0.8, greater than 0.85, greater than 0.9, greater than 0.95, or 1.0.

An RTE foodstuff of one embodiment has a gel strength from about 600 to about 900. In another embodiment, an RTE foodstuff has a gel strength from about 500 to about 1200. In another embodiment, an RTE foodstuff has a gel strength from about 100 to about 2000. In another embodiment, an RTE foodstuff has a gel strength of about up to 3000. In another embodiment, an RTE foodstuff has a gel strength of about at least 100, about at least 150, about at least 200, about at least 250, about at least 300, about at least 350, about at least 400, about at least 450, about at least 500, about at least 600, about at least 700, about at least 800, about at least 900, about at least 1000, about at least 1250, about at least 1500, about at least 1750, or about at least 2000. In another embodiment, an RTE foodstuff has a gel strength of about at least 2500. In another embodiment, a non-baked foodstuff has a gel strength of at least 100, at least 150, at least 200, at least 250, at least 300, at least 350, at least 400, at least 450, at least 500, at least 600, at least 700, at least 800, at least 900, at least 1000, at least 1250, at least 1500, at least 1750, or at least 2000. In another embodiment, a non-baked foodstuff has a gel strength of at least 2500. In another embodiment, a non-baked foodstuff has a gel strength of about 100, about 150, about 200, about 250, about 300, about 350, about 400, about 450, about 500, about 600, about 700, about 800, about 900, about 1000, about 1250, about 1500, about 1750, or about 2000. In another embodiment, a non-baked foodstuff has a gel strength of about 2500.

Gel strength is a measure of the retention of a gel form, based on the gel's resistance to shear. Gel strength is measured by determining the ability of an RTE foodstuff as set forth herein to resist the pressure of a physical probe applied to the surface of the foodstuff. Gel strength of an RTE foodstuff is measured using a texture analyzer (Texture Technologies Corporation, TA-XT2 unit) with a one-half inch round ball probe in a compression test of 6.0 mm at the speed of 1.0 mm per second on the sample of interest in a cylindrical container having dimensions of approximately three inches in diameter and three inches in height. As will be understood by one of skill in the art, the size and shape of the container holding the sample may affect the results of the compression test. In an embodiment, the gel strength is measured on a homogeneous sample of interest. In an embodiment, the gel strength is measured on a sample of interest comprising only one layer. In another embodiment, gel strength is measured on a sample of interest comprising two or more layers. In one embodiment, the two or more layers are of identical gel strength. In another embodiment, the two or more layers are of similar gel strengths. In another embodiment, the two or more layers are of different gel strengths. It will be understood that gel strength may be measured in other ways, using other methods, and that comparisons made of two or more samples must be controlled for the method of testing used in order to make the comparisons meaningful. For example, it will be understood that the gel strength of a single-layer product may be different than a two-layer product, even if the products have identical top layers.

An RTE foodstuff of one embodiment does not contain lecithin. In one embodiment, the fluid mixture used to prepare an RTE foodstuff does not contain lecithin, and the resulting foodstuff cools and sets to provide a resultant foodstuff of desired composition and texture. This is in contrast to the previous understanding in the art that lecithin was required to provide certain desired final foodstuff textures. In fact, lecithin was found to impede the preparation of certain RTE foodstuffs. In another embodiment, an RTE foodstuff contains substantially no lecithin. In another embodiment, an RTE foodstuff contains no added lecithin. In an embodiment, an RTE foodstuff contains about less than 0.1% lecithin, about less than 0.09% lecithin, about less than 0.08% lecithin, about less than 0.07% lecithin, about less than 0.06% lecithin, about less than 0.05% lecithin, about less than 0.04% lecithin, about less than 0.03% lecithin, about less than 0.02% lecithin, or about less than 0.01% lecithin. In an embodiment, an RTE foodstuff contains less than 0.1% lecithin, less than 0.09% lecithin, less than 0.08% lecithin, less than 0.07% lecithin, less than 0.06% lecithin, less than 0.05% lecithin, less than 0.04% lecithin, less than 0.03% lecithin, less than 0.02% lecithin, or less than 0.01% lecithin.

In an embodiment, the fat used in the RTE foodstuff of one embodiment may have a melting point at least about 20° F. higher than the planned storage conditions for the foodstuff. A hard fat, as the term is used herein, is a fat that has a melting point of about 90° F. or higher and preferably a melting point of about 98° F. to about 105° F. The fats may be those of vegetable or animal origin with a high percentage of naturally occurring saturation such as butter fat, cocoa butter, coconut, palm, palm kernel and tallow, or highly unsaturated vegetable fats which have been chemically modified (e.g., hydrogenated or interesterified) to increase the percentage of saturation, and the like, or combinations thereof. In one embodiment, an RTE foodstuff comprises about 50 percent water or greater, and about 5% to about 20% percent fat. In one embodiment, an RTE foodstuff comprises about 50 percent water or greater, and about 10% to about 15% percent fat. In one embodiment, an RTE foodstuff comprises 50 percent water or greater, and about 5% to about 20% percent fat. In one embodiment, an RTE foodstuff comprises 50 percent water or greater, and about 10% to about 15% percent fat. By preparing a water and fat emulsion using these ingredients, one can create an RTE foodstuff having a desirable texture, but also having a relatively high water content and a high water activity.

The gel strength of the compositions disclosed herein may or may not be affected by one or more fat crystallization properties of the fats used. In one aspect, the gel strength may be affected by the rate at which the fats in the composition solidify (e.g., an increase in the rate at which the fats solidify may increase the gel strength). In another aspect, fat crystallization may disrupt fat/protein interactions in the fat/protein emulsion, allowing liquid fat to escape from the emulsion and form a stronger gel-like network among the solid fats. While not wishing to be bound by any particular theory, the process of fat crystallization is believed, in part, to be due to the inclusion of one or more mono- or di-glycerides in an RTE foodstuff. In an embodiment, any fat crystallization promoting agent is useful in the preparation of an RTE foodstuff. In an embodiment, a fat crystallization promoting agent increases the gel strength of an RTE composition.

In one embodiment, the fluid composition used to prepare the RTE foodstuff comprises at least one monoglyceride, or at least one diglyceride, or combinations thereof. Mono- and di-glycerides may be saturated, unsaturated, partially unsaturated. In one embodiment, the fluid composition comprises an unsaturated monoglyceride.

An RTE foodstuff of one embodiment comprises an emulsifier. In an embodiment, an emulsifer comprises a protein source. In another embodiment, an emulsifier does not comprise a protein source. In an embodiment, an emulsifier is not a protein. In another embodiment, an emulsifier is a protein.

An RTE foodstuff of one embodiment comprises a protein source. In one embodiment, a protein source comprises a milk protein. In one embodiment, the milk protein source is nonfat dry milk. In another embodiment, the milk protein source is one or more of nonfat dry milk, caseinates, milk protein concentrates, and milk protein isolates.

The RTE foodstuff may comprise one or more setting agents. In an embodiment, fat is the primary setting agent. In another embodiment, a non-fat setting agent such as gelatin may be added to the RTE foodstuff. In an embodiment, the RTE foodstuff comprises two or more setting agents (e.g., fat plus gelatin).

In one embodiment, the RTE foodstuff comprises one or more texture modifying agents. A texture modifying agent has properties (e.g., structure) that are generally persistent through the process of preparing the RTE foodstuff, and in the final product. In an embodiment, a texture modifying agent is fully hydratable. In another embodiment, a texture modifying agent is sterile. In an embodiment, a texture modifying agent is a particulate ingredient. Particulate ingredients may include, but are not limited to, cereal-based crumbs, flakes, pieces, or other particulates, or combinations thereof. Particulate ingredients may also include grain-based crumbs, flakes, pieces, or other particulates, or combinations thereof. Examples include, but are not limited to, agglomerated grain powders, agglomerated starches, and whole grains. In one embodiment, a texture modifying agent may be baked, cooked or otherwise processed before addition of the texture modifying agent to the fluid mixture containing the ingredients for the RTE foodstuff. In an embodiment, a texture modifying agent may be baked, cooked or otherwise processed before addition to the fluid mixture that is subject to processing, such as mixing, homogenization, heating, filling, layering and cooling of an RTE foodstuff into a suitable container.

In an embodiment, the texture modifying ingredient is used to create a unique texture within a composition disclosed herein. Such a composition includes at least 1% weight particulate material, measured as disclosed elsewhere herein. In an embodiment, particle size is measured by passing the foodstuff containing the particulate material through multiple sieves of known sizes and comparing the particles retained on each sieve. The particulate fraction retained on each sieve can then be used to calculate the particle size of the foodstuff Some exemplary RTE foodstuffs, when containing particulate texture modifying agents, include at least about 1% weight fraction of particulate ingredients, and preferably, at least about 5% weight fraction of particulate ingredients.

The weight fraction is determined by determining the percentage of weight of particulate matter as compared to the total sample weight prior to processing for particle size determination. In an embodiment, particle size is measured by passing the foodstuff containing the particulate material through a sieve of known size and analyzing the particles retained on the sieve. In another embodiment, particle size is measured by passing the foodstuff containing the particulate material through multiple sieves of known sizes and comparing the particles retained on each sieve. The particulate fraction retained on each sieve can then be blot dried and weighed in order to calculate the particle size fraction for the foodstuff The measurements are performed on hydrated, blot-dried particles. Some exemplary RTE foodstuffs, when containing particulate texture modifying agents, include at least about 1% weight fraction of particulate ingredients, and preferably, at least about 5% weight fraction of particulate ingredients. Some exemplary RTE foodstuffs, when containing particulate texture modifying agents, include at least 1% weight fraction of particulate ingredients, and preferably, at least 5% weight fraction of particulate ingredients. The weight fraction is determined by determining the percentage of weight of particulate matter as compared to the total weight of the foodstuff sample of interest prior to processing for particle size determination. The weight fraction is determined using weight of particle retention on a 100 μm screen, post process. Particles are blot dried then weighed. In an embodiment, one layer of US#18 sieve on the top and one layer of US#140 sieve on the bottom are used to facilitate the separation process. The weight fractions for each sieve/screen is then added together to give the final weight fraction. In an embodiment, an exemplary non-baked foodstuff containing particulate texture modifying agents includes at least about 0.1%, at least about 0.5%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, or at least about 50% weight fraction of particulate texture modifying agents. In an embodiment, an exemplary non-baked foodstuff containing particulate texture modifying agents includes at least 0.1%, at least 0.5%, at least 1%, at least 2%, at least 3%, at least 4%, at least 5%, at least 6%, at least 7%, at least 8%, at least 9%, at least 10%, at least 15%, at least 20%, at least 25%, at least 30%, at least 40%, or at least 50% weight fraction of particulate texture modifying agents. In another embodiment, a foodstuff includes greater than 50% weight fraction of particulate texture modifying agents.

In one embodiment, particulate texture modifying agents are selected based on their properties of agglomeration. In one embodiment, particulate texture modifying agents used in the preparation of an RTE foodstuff comprise particulate ingredients which agglomerate, wherein such particulate ingredients persist in the agglomerated state throughout processing steps. In an embodiment, agglomeration can be achieved by compressing, extruding, compacting, or by using other such suitable processing methods, or any combination thereof. In an embodiment, the particulate ingredients maintain at least 90% of the agglomeration from start to finish of the process of preparing the RTE foodstuff.

In another embodiment, particulate texture modifying agents are selected based on their properties of hydration. In one embodiment, the particulate ingredients are able to be hydrated. As will be understood by the skilled artisan, particulate ingredients of different structure and composition will be hydratable to varying degrees. The ability of a particulate ingredient to be hydrated may contribute to the ease with which the particulate ingredient may be pasteurized or sterilized.

In an embodiment, an exemplary RTE foodstuff is aerated prior to cooling and setting. Aeration of the foodstuff may be used to enhance the final texture of the RTE foodstuff.

In one embodiment, aeration provides a distinct and/or enhanced baked-goods like texture. In one embodiment, a method of making an RTE foodstuff includes aeration of the fluid mixture during the final cooling of the foodstuff. In an embodiment, one or more homogenization steps precede any aeration steps.

The foodstuff can be heat pasteurized or sterilized under ultra-high temperature (UHT) conditions and is useful as an RTE foodstuff either alone or in combination with other foodstuff components (e.g., pudding, mousse, ready-to-eat fudge, and the like). Typically UHT treatment may be carried out under high temperatures and short time conditions (e.g., about 280° F. for about 15 seconds) in order to kill potentially dangerous microorganisms. Other temperature and time profiles normally used for pasteurization and/or sterilization can also be used so long as they provide the desired protection.

To provide an RTE foodstuff, especially when combined with other components such as pudding, mousse, and the like, the foodstuff set forth herein preferably has a long shelf-life. To achieve an RTE foodstuff having a long shelf-life, the foodstuff in one embodiment may be pasteurized or sterilized at ultra-high temperatures. In another embodiment, the RTE foodstuff can additionally be prepared using aseptic techniques. In another embodiment, the RTE foodstuff is not pasteurized. In yet another embodiment, the RTE foodstuff is not pasteurized, but is packaged aseptically. In an embodiment, the UHT processed RTE foodstuff has a shelf life of greater than about 6 months at ambient temperatures for aseptically packaged products and greater than about 3 months under refrigerated conditions for non-aseptically packaged products. In one embodiment, the shelf life is at least 30 days. In another embodiment, the shelf life is at least 60 days. In yet another embodiment, the shelf life is at least 90 days. In one embodiment, the RTE foodstuff can be stored at room temperature. In another aspect, the RTE foodstuff can be stored under refrigeration. In an embodiment, an organoleptic test is used to determine shelf life. In another embodiment, a microbiological test is used to determine shelf life. In another embodiment, two or more tests are used in combination to determine shelf life.

An RTE foodstuff may comprise a single layer. In another embodiment, an RTE foodstuff may comprise two or more layers. In one embodiment, when multiple layers are present, one or more layers may comprise the same RTE foodstuff. In another embodiment, when multiple layers are present, various layers may be comprised of two or more different RTE foodstuff products. In yet another embodiment, when multiple layers are present, one or more layers may be comprised of an RTE foodstuff, and one or more layers may be comprised of a foodstuff other than the RTE foodstuff. As used herein, “layers” or “discrete layers” is intended to include separate layers of the different components as well as inclusions of one component in a layer of the other component. Examples of components include puddings, gels, mousses, custards, flans, yogurts, fudges, whipped toppings, chocolates, chocolate chips or bits, jellies, sauces, cookies, cookie dough, fruits, and the like whether imitation or real. In an embodiment, components formed from candies, chocolates chips or bits, cookie dough, and/or fruits are in the form of inclusions.

When two different layers, or a layer and an inclusion, contact one another, substantial changes in texture and/or color may occur over time if the textures and/or colors are appreciably different. Texture stability between the layers, or between a layer and an inclusion, can be achieved by matching the soluble solids ratio between the different components. Within each component (e.g., layer, inclusion), the soluble solids ratio is defined as the total weight of soluble solids in the layer, divided by the sum of the weight of water and weight of soluble solids in that layer, as shown in the following formula: Soluble Solids Ratio=(Soluble Solids/(Water+Soluble Solids))*100.

Two or more layers or components are considered to have “matched” soluble solids ratios when the soluble solids ratio of adjacent components are within about 12 percent of each other. In another embodiment, two or more layers or components are considered to have “matched” soluble solids ratios when the soluble solids ratio of adjacent components are within about 6 percent of one another. In another embodiment, two or more layers or components are considered to have “matched” soluble solids ratios when the soluble solids ratio of adjacent components are within about 1 percent of one another. In determining the difference in soluble solid ratios between two adjacent components, it is the relative difference rather than the absolute difference which is used. Thus, by way of a non-limiting example, two adjacent layers having soluble solid ratios of 22.4 percent and 23.7 percent, respectively, have a relative difference of about 5.8 percent (as opposed to the absolute difference of 1.3 percent between the two layers). It will also be understood that two or more layers or components are considered to have “matched” soluble solids ratios when the soluble solids ratio of adjacent components are within about 18 percent of one another, within about 15 percent of one another, within about 12 percent of one another, within about 9 percent of one another, within about 6 percent of one another, within about 3 percent of one another, within about 1 percent of one another, or within about less than 1 percent of one another.

In one embodiment, a method for preparing a multi-texture RTE foodstuff includes preparing a first component with a first soluble solids ratio, preparing a second component with a second soluble solids ratio, the second component being an RTE foodstuff, and combining the first and second components. The soluble solids ratios of such a product may preferably have a relative difference of about less than twelve percent.

Taking into consideration the compositions and methods exemplified herein, it will be understood that depending upon the desired product and process, optional ingredients may be used. Examples of optional ingredients include high-intensity sweeteners, such as stevia, saccharin, SUCRALOSE, ASPARTAME, and ACESULFAME, and sweeteners such as fructose, glucose, dextrose, corn syrup, corn syrup solids, honey, and the like. Preferred water binders include cocoa for chocolate type fudges and modified starches for non-chocolate type fudges. If desired, other known water binders can be used. Examples of such other water binders include grains, gelling agents, gelatins, gums, fibers, maltodextrin, and the like. Mixtures of such water binders can be used if desired.

In an exemplary embodiment, an RTE foodstuff comprises about 50% to about 70% water; about 10% to about 20% hard fat; about 1% to about 5% milk protein source; and about 0.1% to about 20% water binder, and the foodstuff has a gel strength of about 600 to about 900 and does not comprise lecithin. In another exemplary embodiment, a method for preparing an RTE foodstuff comprises preparing a fluid composition comprising about 50% to about 70% water, about 10% to about 20% hard fat, about 1% to about 5% protein source, and about 0.1% to about 20% water binder; and allowing the fluid composition to cool to form a foodstuff having a gel strength of about 100 to about 2000, wherein the fluid composition is fluid above a temperature of about 80° F., further wherein the foodstuff does not comprise lecithin.

In one embodiment, the fluid composition is homogenized prior to cooling. In another embodiment, the fluid composition is homogenized after batching but prior to processing. In an embodiment, one or more homogenization steps precede any aeration steps. In an embodiment, the fluid composition is homogenized to obtain a particle size of 5 microns or less. It will be understood, however, that not all fat present in the fluid composition may be homogenized, nor does it need to be according to the disclosure herein.

The RTE foodstuff may be further described by the following examples. It should be recognized that variations based on the inventive features are within the skill of the ordinary artisan, and that the scope of the invention should not be limited by the examples. To properly determine the scope of the present disclosure, an interested party should consider the claims herein, and any equivalent thereof. In addition, all citations herein are incorporated by reference, and unless otherwise expressly stated, all percentages are by weight.

### EXAMPLE 1

### Non Cocoa Containing RTE Foodstuff With and Without Fat Crystal Promoting Agent

This example illustrates how the addition of a fat crystal promoting agent can change the texture of an RTE foodstuff from a soft pudding to a firm fudge. Hot water (145° F.), 223 pounds, was batched, with 0.8 pounds of sodium stearoyl lactylate, 20 pounds of nonfat dry milk, 94 pounds of sugar, 10.68 pounds of modified starch, 50 pounds of hydrogenated coconut and palm kernel oil (NEUTRESCA 77-25; Aarhus Karlsham USA Inc., Malmo, Sweden), pyrophosphates, vanilla flavor, and one batch included 2 pounds of fat crystallizer (Dimodan rd ka monoglyceride, Danisco, Copenhagen, Denmark). The mixtures were homogenized at 500/2500 psi and collected. The mixtures were then heated to 285° F. through scraped surface heat exchangers, held for 2 seconds, cooled to 90° F. through scraped surface heat exchangers, collected into cups, sealed, and refrigerated. After 24 hours of refrigeration, the samples without the fat crystallizer had a gel strength of 0, and the samples with the fat crystallizer had a gel strength of 938.

### EXAMPLE 2

### Cocoa Containing RTE Foodstuff With Fat Crystal Promoting Agent

This example describes a reduced fat high moisture chocolate RTE foodstuff with a firm chocolate fudge like texture. Hot water (145° F.), 220 pounds, was batched with 0.8 pounds of sodium stearoyl lactylate, 20 pounds of nonfat dry milk, 67 pounds of sugar, 4 pounds of modified starch, 50 pounds of melted coconut palm kernel oil (NEUTRESCA 77-25), 36 pounds of cocoa, sucralose, vanilla flavor, and 2 pounds of fat crystallizer (DIMODAN rd ka monoglyceride). The mixture was homogenized at 500/2500 psi and collected. The mixture was then heated to 285° F. through scraped surface heat exchangers, held for 2 seconds, cooled to 90° F. through scraped surface heat exchangers, collected into cups, sealed, and refrigerated. After 24 hours of refrigeration, the samples had a gel strength of 1445.

### EXAMPLE 3

### Cocoa Containing RTE Foodstuff With Fat Crystal Promoting Agent Plus Gelatin

This example describes a reduced fat high moisture chocolate RTE foodstuff with a very firm chocolate candy bar like texture. Hot water (145° F.), 245 pounds, was batched with 0.8 pounds of sodium stearoyl lactylate, 20 pounds of non fat dry milk, 46 pounds of sugar, 8 pounds of modified starch, 50 pounds of melted coconut palm kernel oil (NEUTRESCA 77-25), 24 pounds of cocoa, sucralose, vanilla flavor, 2 pounds of fat crystallizer (DIMODAN rd ka monoglyceride), and 4 pounds of gelatin (240 bloom). The mixture was homogenized at 500/2500 psi and collected. The mixture was then heated to 285° F. through scraped surface heat exchangers, held for 2 seconds, cooled to 90° F. through scraped surface heat exchangers, collected into cups, sealed, and refrigerated. After 24 hours of refrigeration, the samples had a gel strength of 2268.

### EXAMPLE 4

### Cocoa-Containing RTE Foodstuff Plus Gelatin Without Fat Crystal Promoting Agent

This example describes a reduced fat high moisture chocolate RTE foodstuff with a firm chocolate fudge like texture. Hot water (145° F.) 233 pounds, was batched with 0.75 pounds of sodium stearoyl lactylate, 15 pounds of non fat dry milk, 37 pounds of sugar, 11.25 pounds of modified starch, 47 pounds of melted cocoa butter (NCB-HD703-758), 26.25 pounds of cocoa, Sucralose, acesulfame potassium, vanilla flavor, and 4.7 pounds of gelatin (240 bloom). The mixture was homogenized at 500/2500 psi and collected. The mixture was then heated to 285° F. through scraped surface heat exchangers, held for 2 seconds, cooled to 95° F. through scraped surface heat exchangers, collected into cups, sealed, and refrigerated. After 24 hours of refrigeration, the samples had a gel strength of 144.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

The term “about” as used herein refers to a value that is +/−10% of the value to which it refers, unless otherwise defined in any particular embodiment or example. By way of a non-limiting example, the term “about 50% water” refers to an amount of water ranging from 45% to 55%.

It is to be understood that at least some of the descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

I/we claim:

1. A method for preparing a foodstuff, the method comprising (a) preparing a fluid composition comprising about 50% to about 70% water, about 7% to about 17% hard fat, about 0.1% to about 5% protein source, and about 0.1% to about 20% water binder; (b) heating the fluid composition to a temperature above the melting point of the hard fat, and (c) allowing the fluid composition to cool to form a foodstuff having a gel strength of about at least 100, wherein the fluid composition is fluid above a temperature of about 80° F. further wherein the foodstuff does not comprise lecithin.

2. The method of claim 1, wherein following step (a), the fluid composition is heated at a temperature and time sufficient for pasteurization.

3. The method of claim 1, further wherein the foodstuff has a water activity about at least 0.85 and has about less than 5% evaporation during and/or after processing.

4. The method of claim 1, wherein the hard fat has a melting point above 90 degrees Fahrenheit.

5. The method of claim 4, wherein the melting point is about 98 degrees Fahrenheit to about 105 degrees Fahrenheit.

6. The method of claim 2, further comprising an ultra high temperature (UHT) step.

7. The method of claim 1, wherein the protein source is nonfat dry milk or a protein-based emulsifier.

8. The method of claim 1, wherein the fluid composition further comprises an ingredient selected from the group consisting of a monoglyceride, a diglyceride, or a combination thereof.

9. The method of claim 1, wherein the water binder comprises compositions selected from the group consisting of a cocoa, starch, gelatin, gums, grains, gelling agents, fiber, dextrins or combinations thereof.

10. The method of claim 1, wherein the fluid composition further comprises at least one texture-modifying particulate ingredient.

11. The method of claim 1, further comprising an aeration step.

12. The method of claim 1, further comprising a homogenization step.

13. A foodstuff prepared according to claim 1.

14. A foodstuff comprising (a) about 50% to about 70% water; (b) about 7% to about 17% hard fat; (c) about 0.1% to about 5% protein source; and (d) about 0.1% to about 20% water binder, the foodstuff having a gel strength of about at least 100, wherein the foodstuff does not comprise lecithin.

15. The foodstuff of claim 14, further wherein the foodstuff has a water activity about at least 0.85.

16. The foodstuff of claim 14, wherein the hard fat has a melting point above 90 degrees Fahrenheit.

17. The foodstuff of claim 14, wherein the composition further comprises at least one texture-modifying particulate ingredient.

18. The foodstuff of claim 14, further wherein the composition is homogenized prior to cooling.

19. The foodstuff of claim 14, wherein the composition further comprises an ingredient selected from the group consisting of a monoglyceride, a diglyceride, or a combination thereof.

20. A method for preparing a multi-texture, ready-to-eat foodstuff comprising:
(a) preparing a first component with a first soluble solids ratio;
(b) preparing a second component with a second soluble solids ratio, wherein the second component is a foodstuff comprising (i) about 50% to about 70% water; (ii) about 7% to about 17% hard fat; (iii) about 0.1% to about 5% protein source; and (iv) about 0.1% to about 20% water binder, the foodstuff having a gel strength of about at least 100, further wherein the foodstuff does not comprise lecithin; and
(c) combining the first and second components to form the multi-texture, ready-to-eat foodstuff;
wherein the first and second soluble solid ratios have a relative difference of less than about 12 percent.

21. A multi-texture, ready-to-eat foodstuff comprising:
(a) a first component with a first soluble solids ratio; and
(b) a second component with a second soluble solids ratio, wherein the second component is a foodstuff comprising (i) about 50% to about 70% water; (ii) about 7% to about 17% hard fat; (iii) about 0.1% to about 5% protein source; and (iv) about 0.1% to about 20% water binder, the foodstuff having a gel strength of about at least 100, further wherein the foodstuff does not comprise lecithin;
wherein the first and second components are arranged in discrete layers to form the multi-texture, ready-to-eat foodstuff and wherein the first and second soluble solid ratios have a relative difference of less than about 12 percent.

22. The method of claim 1, wherein the composition further comprises a fat crystallization promoter.

23. The foodstuff of claim 14, further comprising a fat crystallization promoter.

24. A method for preparing a foodstuff, the method comprising (a) preparing a fluid composition comprising about 50% to about 70% water, about 7% to about 17% hard fat, about 0.1% to about 5% emulsifier, and about 0.1% to about 20% water binder; (b) heating the fluid composition to a temperature above the melting point of the hard fat, and (c) allowing the fluid composition to cool to form a foodstuff having a gel strength of about at least 100, wherein the fluid composition is fluid above a temperature of about 80° F. further wherein the foodstuff does not comprise lecithin.

25. A method for preparing a foodstuff, the method comprising (a) preparing a fluid composition comprising about 50% to about 70% water, about 7% to about 17% hard fat, about 0.1% to about 5% non-protein emulsifier, and about 0.1% to about 20% water binder; (b) heating the fluid composition to a temperature above the melting point of the hard fat, and (c) allowing the fluid composition to cool to form a foodstuff having a gel strength of about at least 100, wherein the fluid composition is fluid above a temperature of about 80° F. further wherein the foodstuff does not comprise lecithin

26. A method for preparing a foodstuff, the method comprising (a) preparing a fluid composition comprising about 50% to about 70% water, about 7% to about 17% hard fat, about 0.1% to about 5% protein source, and about 0.1% to about 20% water binder; (b) heating the fluid composition to a temperature above the melting point of the hard fat, and (c) allowing the fluid composition to cool to form a foodstuff having a gel strength of about at least 100, wherein the fluid composition is fluid above a temperature of about 80° F. further wherein the foodstuff comprises substantially no lecithin.

27. A foodstuff comprising (a) about 50% to about 70% water; (b) about 7% to about 17% hard fat; (c) about 0.1% to about 5% protein source; and (d) about 0.1% to about 20% water binder, the foodstuff having a gel strength of about at least 100, further wherein the foodstuff comprises substantially no lecithin.
